(19) United States
(12) Patent Application Publication
(10) Pub. No.: US 2003/0226148 A1
(43) Pub. Date: Dec. 4, 2003

(54) Removable vehicular audio-video systems

(76) Inventor: Andrew H. Ferguson, Garden Grove, CA (US)

Correspondence Address: Kenneth W. Float, The Law Offices of Kenneth W. Float, P.O. Box 80790, Rancho Santa Margarita, CA, 92688, US

(21) Appl. No.: 10/158,245

(22) Filed: May 30, 2002

(51) Int. Cl. H04N 7/18

(52) U.S. Cl. 725/75; 725/77

(57) ABSTRACT

Removable audio-video systems that are easily installed in a vehicle without the need for cumbersome fixed wiring installations. The present invention comprises a cover, in the form of a seat cover or headrest cover, that is fitted over a seat, headrest or both. The cover drapes over the back of the seat, or is fitted to cover the seat, and is attached to the seat using one or more straps that are attached to the underside of the seat. A video monitor and an FM transmitter are affixed to the rear surface of the cover or are disposed in a pocket of the cover. A pouch or pocket having a lid or top flap is affixed to the rear surface of the cover that houses a video reproducer, such as a DVD player. A game port is preferably located in the same pouch or pocket as the DVD player or FM transmitter to allow playing of video games. The video reproducer (DVD player) has audio and video output cables that are coupled to the game port. The game port has a video output cable that is coupled to the video monitor and audio output cables that are coupled to the FM transmitter. Electrical power for all components is provided by power leads coupled to a cigarette lighter adapter that plugs into a cigarette lighter or auxiliary power connector of the vehicle. The video monitor displays the output of the DVD player or auxiliary input source, while the FM transmitter wirelessly broadcasts audio signals on a selectable FM frequency to wireless headphones or a vehicle audio system.

### BACKGROUND

The present invention relates generally to audio-video systems, and more particularly, to removable vehicle audio-video systems.

Heretofore, most vehicle entertainment systems, such as those used in passenger automobiles, vans and recreational vehicles, have had audio-video systems installed in them that incorporate a video cassette recorder and a tuner, for example, that are coupled to a television monitor and a vehicle audio system. This arrangement is cumbersome in that a great deal of wiring is required to be run between the components of the audio-video systems within the vehicle.

In particular, these systems are installed as aftermarket products in the vehicles, and provisions for running the additional wiring are not made by the vehicle manufacturer. As a result, installing such systems is costly and time consuming. In many conventional systems, each of the components must be separately connected to vehicle power and ground, which means that additional wiring is required.

Furthermore, in general, conventional audio-video systems are permanently installed in the vehicle, which is costly for both installation, and removal if this is desired. Consequently, use of the audio-video systems in a different vehicle is generally prohibited.

U.S. patent application Ser. No. 20010008266, published Jul. 19, 2001, “discloses “A mount 10 for detachably mounting a screen of an in-car video entertainment system to the rear of a headrest of a vehicle comprises fixings 15 for engagement by the rear of the video screen. The mount 10 enables the video screen to be secured firmly in position against the rear surface of the headrest, so that rear-seat passengers can view the video output from a computer games device, video cassette/tape recorder or video disc player etc. The mount may be fitted to any existing headrest without any modification to the headrest being required.” However, nothing is disclosed or suggested in this patent application regarding a fully-integrated audio-video system that may be attached to a vehicle seat.

U.S. Pat. No. 6,216,927, issued Apr. 17, 2001, discloses a portable video entertainment system that includes a video cassette recorder and a LCD monitor that are carried together in a pouch or bag that may be strapped in between the two front seats of a vehicle and suspended there by the strapping system. However, nothing is disclosed or suggested in this patent regarding an audio-video system that may be attached to a single vehicle seat. Furthermore, there is no disclosure of suggestion therein relating to a fully integrated audio-video system. In particular, nothing is disclosed or suggested in this patent concerning interfacing n audio signal with the vehicle's radio system or wireless headphones. Furthermore, nothing is disclosed or suggested in this patent relating to the ability of the system to interface with multiple monitors, thus providing multiple viewing positions within a vehicle. Finally, while this patent highlights the portability of the system, nothing is disclosed or suggested regarding a system having the benefits of a fully installed vehicle audio-video system which may also be removed from the vehicle.

It would therefore be desirable to have removable vehicle audio-video systems that are easily installed in and removed from a vehicle while having the benefits of a fully installed and fully integrated system.

### SUMMARY OF THE INVENTION

To accomplish the above and other objectives, the present invention provides for a variety of removable audio-video systems that are easily installed in a vehicle without the need for cumbersome wiring installations required for installation of conventional systems or the limited features and obvious “carry on” nature of other portable systems. The present invention comprises a cover, which may comprise a seat cover, headrest cover or removable headrest with integrated screen and apron, that is fitted over seat, headrest or both. The cover may be made of leather, vinyl, or cloth, for example, so that it matches a vehicle's interior materials.

In the headrest cover embodiments of the audio-video systems, a portion of the cover drapes over the back of the seat and is attached to the seat by means a plurality of straps that are hooked or otherwise attached to the underside of the seat. Stretchable straps may be employed, although adjustable straps are preferred. In the seat cover embodiment of the audio-video systems, the cover completely covers the front and back of the seat and headrest.

A video monitor is affixed onto the rear surface of the cover or into a pocket within the cover, preferably to the headrest portion of the cover. An FM transmitter is also affixed to the rear surface of the cover or into a pocket within the cover, in a convenient location part way down the back side of the cover. A pouch having a lid or top flap is affixed to the rear surface of the cover, preferably near the bottom of the back side of the cover. A video reproducer, which is preferably a digital video disc (DVD) player, such as a single disc, slot-type DVD player, is disposed in the pouch with its front panel located adjacent to the lid or top flap of the pouch. A game port (i.e., an auxiliary audio-video input for games, and the like) is preferably located in the same pouch or pocket as the DVD player or FM transmitter.

The video reproducer or DVD player has a video output cable that is preferably routed inside the cover and coupled to the game port. The video reproducer or DVD player has audio output cables that are also preferably routed inside the cover that are also coupled to the game port. The game port receives the video and audio signals from the DVD player. It also has auxiliary audio and video input for video games or other sources. The DVD audio and video signals are directly passed through the game port to the video monitor and the FM transmitter, unless an auxiliary source, such as a video game, is plugged into the game port. In this case, the game port automatically selects the new source and sends the signal to the video monitor or FM transmitter, and no switching is required. Electrical power for the video reproducer (DVD player), the video monitor and the FM transmitter is provided by means of power leads coupled to a cigarette lighter adapter that plugs into a cigarette lighter or auxiliary power connector of the vehicle. This provides for a simple “plug-and-play” audio-video system.

The video monitor displays the output of the video reproducer (DVD player) or auxiliary source which may be easily viewed from a rear passenger seat, while the FM transmitter wirelessly broadcasts audio signals output by the video reproducer (DVD player) or auxiliary source to wireless headphones, or to a vehicle audio system, on a selectable FM frequency. A passenger in the rear seat of the vehicle may easily view a movie by simply lifting the top flap of the DVD player pouch, inserting a video disc into the video reproducer (DVD player), playing the video disc, and either listening to the audio privately on the headphones, or by way of the vehicle audio system.

A second system may be added on to an adjacent seat to provide for an additional viewing position. This second system may be used as a completely independent system by including a second DVD player or it may be set up as a companion system to the primary system if it is plugged into the auxiliary output connector of the first system. The DVD player in the second system would then be eliminated, thus saving user costs. The second system may be used to view the DVD source of the primary system or independently utilize a video game or other auxiliary source via the game port.

The present invention eliminates the need for hardwired, fixed installation of the audio-video system in the vehicle, while maintaining all of its function and features, and yet permits its removal and reuse in another vehicle, if desired. The costs of installation and removal of the audio-video system are thus eliminated.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIGS. 1a and 1b illustrate a first embodiment of a removable audio-video system in accordance with the principles of the present invention;

FIGS. 2a and 2b illustrate a second embodiment of a removable audio-video system in accordance with the principles of the present invention;

FIGS. 3a and 3b illustrate a third embodiment of a removable audio-video system in accordance with the principles of the present invention; and

FIGS. 4a and 4b illustrate a fourth embodiment of a removable audio-video system in accordance with the principles of the present invention.

### DETAILED DESCRIPTION

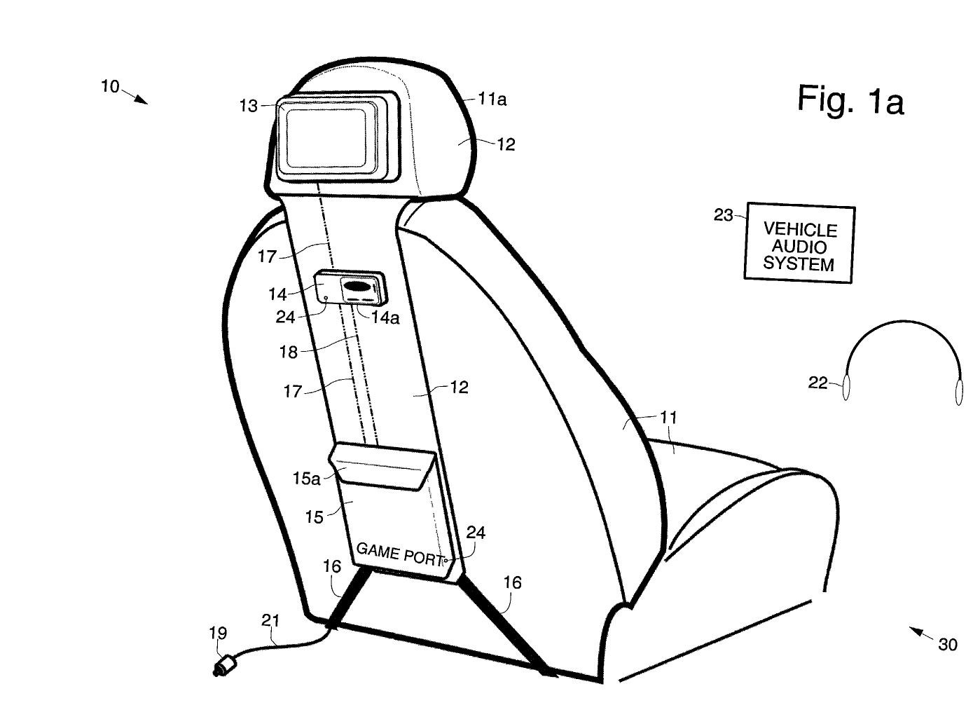

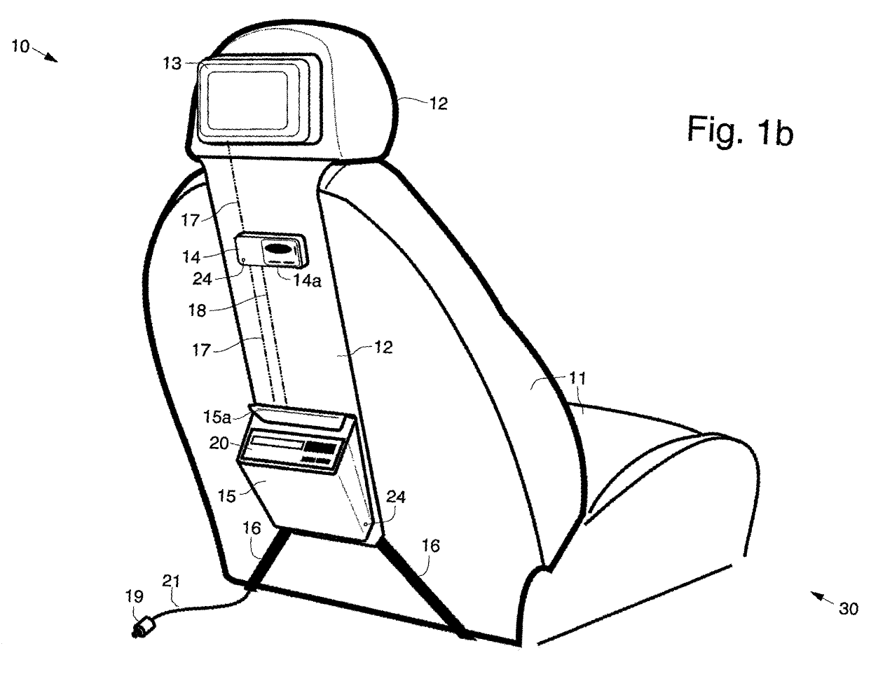

Referring to the drawing figures, FIGS. 1a and 1b illustrate a first embodiment of a removable audio-video system 10 in accordance with the principles of the present invention. FIG. 1a illustrates the removable audio-video system 10 installed over a seat 11 of a vehicle 30, while FIG. 1b shows the removable audio-video system 10 during operation.

The removable audio-video system 10 is preferably designed for use in a vehicle 30, such as an automobile, van, or sport utility vehicle, for example. However, it is to be understood that the present invention may be adapted for use in any vehicle 30 having a front seat and rear seat passengers, and is not limited to use in any specific application.

The first embodiment of the removable audio-video system 10 comprises a cover 12, which is in the form of a headrest cover 12, that is fitted over a headrest 11a of the seat 11 of the vehicle 30. The cover 12 may be made of leather, vinyl, or cloth, for example, so that it matches the interior of the vehicle 30, if desired.

A portion of the cover 12 drapes over the back of the seat 11 and it attached to the seat 11 by means a plurality of straps 16 that are hooked or otherwise attached to the underside of the seat 11. Stretchable straps 16 may be employed, although adjustable straps 16 are preferred.

A video monitor 13 is affixed to the rear surface of the cover 12, preferably to the portion of the cover 12 covering the headrest 11a. An FM transmitter 14 is also affixed to the rear surface of the cover 12, in a convenient location part way down the back side of the cover 12. The FM transmitter 14 is preferably disposed in a pouch 14a or pocket 14a affixed to the rear surface of the cover 12.

A pouch 15 or pocket 15 having a lid 15a or top flap 15a is affixed to the rear surface of the cover 12, preferably near the bottom of the back side of the cover 12. A video reproducer 20 (FIG. 1b), which is preferably a single disc, slot-type digital video disc (DVD) player 20, is disposed in the pouch 16 with its front panel located adjacent to the lid 16a or top flap 15a of the pouch 15.

A game port 24 comprising an auxiliary audio-video input for games and the like, is preferably located in the same pouch 15, 14a or pocket 15, 14a as the DVD player or FM transmitter 14 that allows video games to be played using the system 10. The game port 24 comprises an automatic switching device that automatically switches between the DVD player and an auxiliary input source.

The video reproducer 20 or DVD player 20 has a video output cable 17 that is preferably routed inside the cover 12 that is coupled to the video monitor 13. The video reproducer 20 or DVD player 20 has audio output cables 18 that are also preferably routed inside the cover 12 that are coupled to the FM transmitter 14. Electrical power for the video reproducer 20 (DVD player 20), the video monitor 13 and the FM transmitter 14 is provided by means of power leads 21 coupled to a cigarette lighter adapter 19 that plugs into a cigarette lighter or auxiliary power connector of the vehicle 30. Currently-available sport utility vehicle and minivans, for example, has one or more auxiliary power connectors in the rear of the vehicle 30. This single power connection provides for a simple “plug-and-play” audio-video system 10.

The audio-video system 10 is easily installed in the vehicle 30 by sliding the cover 12 over the headrest 11, pulling the drape portion of the cover 12 downward over the back of the seat 11, and securing the straps 16 to the bottom of the seat 11. The adapter 19 may then be plugged into a convenient cigarette lighter or auxiliary (accessory) power connector of the vehicle 30. The audio-video system 10 is easily removed from the vehicle 30 by loosening the straps 16 and lifting the cover 12 off of the seat 11. The present invention thus eliminates the need for hardwired, fixed installation of an audio-video system in the vehicle 30, and permits its removal and reuse in other vehicle 30, if desired.

A passenger in a rear seat of the vehicle 30 may easily view a movie by simply lifting the top flap 15a of the DVD player pouch 15, inserting a video disk into the DVD player 20 and playing the video disk. The video monitor 13 displays the output of the DVD player 20 which may be easily viewed from the rear passenger seat, while the FM transmitter 14 wirelessly broadcasts audio signals output by the DVD player 20 to wireless headphones 22, or to a vehicle audio system 23, on a preselected FM frequency, for passenger listening.

The FM transmitter 12 transmits the audio signals on a predetermined FM channel, typically 88.7 MHz or 89.1 MHz, although other may be readily employed. The vehicle audio system 23 outputs audio signals to its audio speakers (not shown) that may be heard by passengers of the vehicle 30. The FM transmitter 12 also transmits the audio signals to the wireless headphones 22, which contain an FM receiver and antenna, that allows private listening.

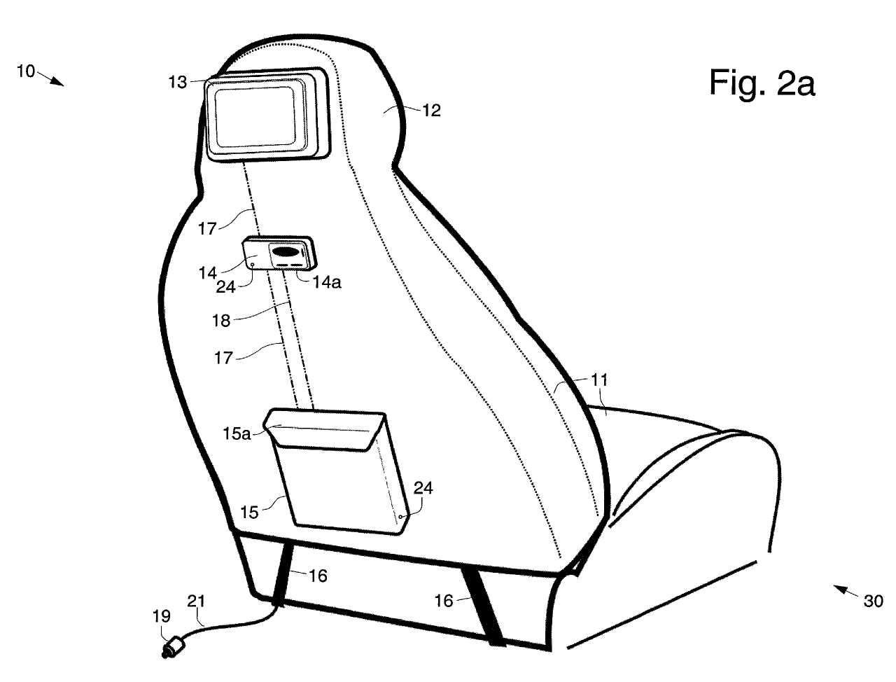

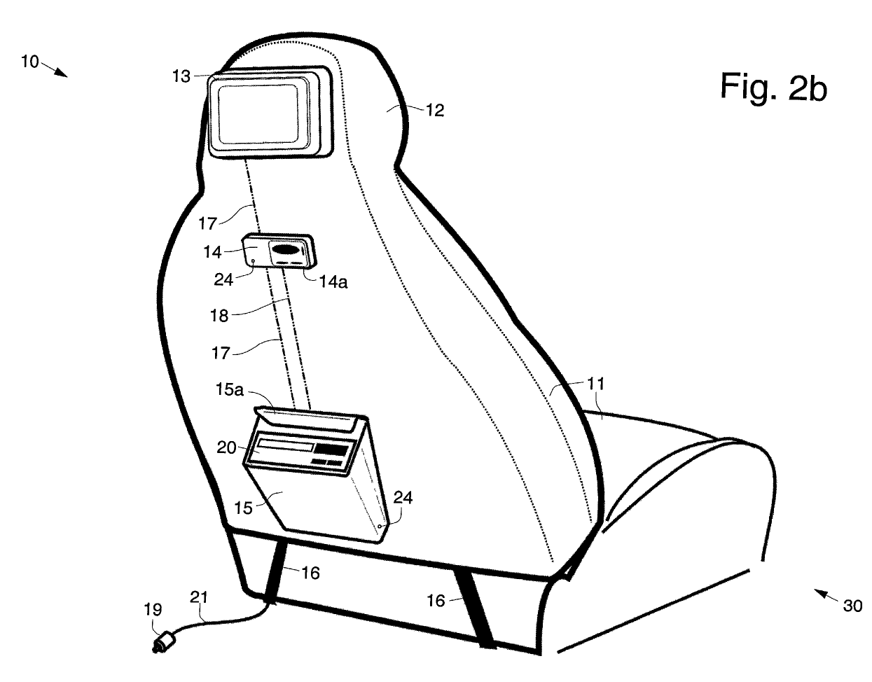

FIGS. 2a and 2b illustrate a second embodiment of a removable audio-video system 10 in accordance with the principles of the present invention. The second embodiment of a removable audio-video system 10 comprises a seat cover 12 that is fitted over the seat 11 in the vehicle 30. The cover 12 is fitted to cover the entire seatback portion of the seat 11. The balance of the second embodiment of the removable audio-video system 10 is substantially the same as the first embodiment, and contains substantially the same components and connections.

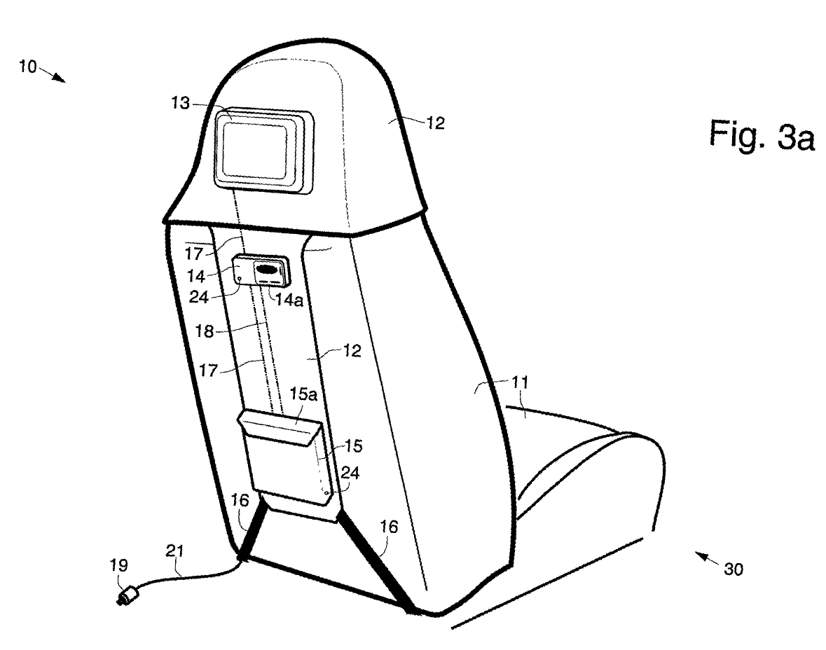

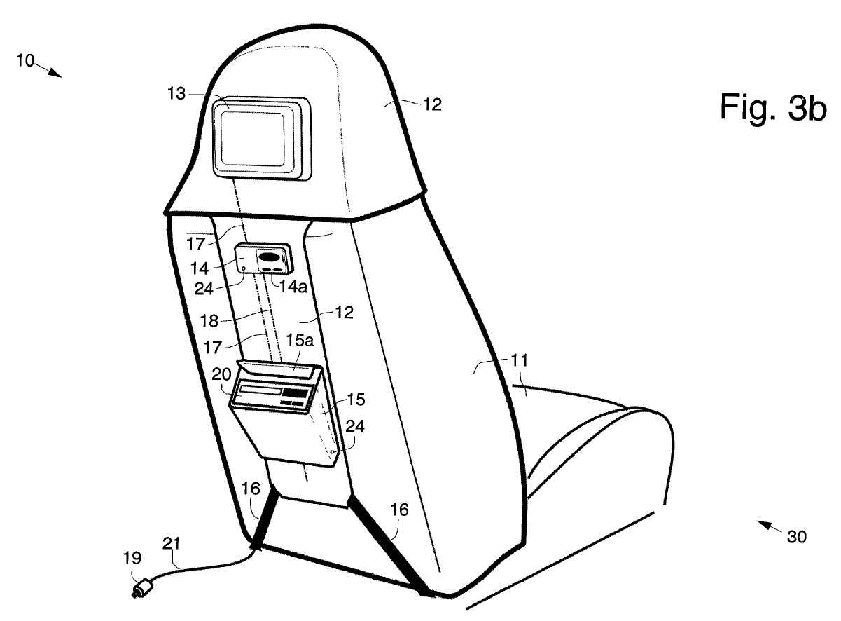

FIGS. 3a and 3b illustrate a third embodiment of a removable audio-video system 10 in accordance with the principles of the present invention. The third embodiment of the removable audio-video system 10 is used with seats 11 having high-back seats without separate, adjustable headrests. The balance of the third embodiment of the removable audio-video system 10 is substantially the same as the first embodiment, and contains substantially the same components and connections.

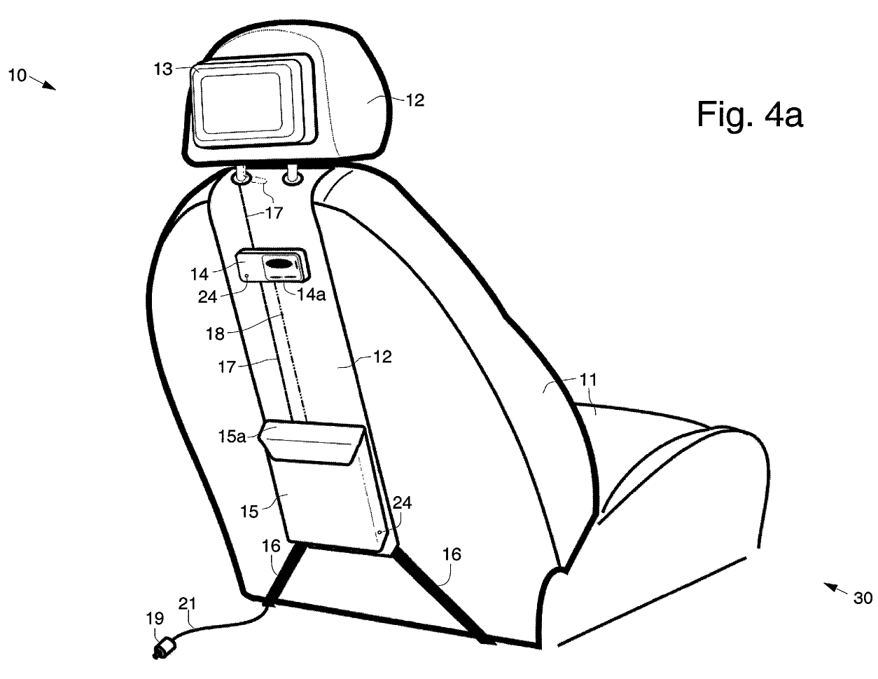

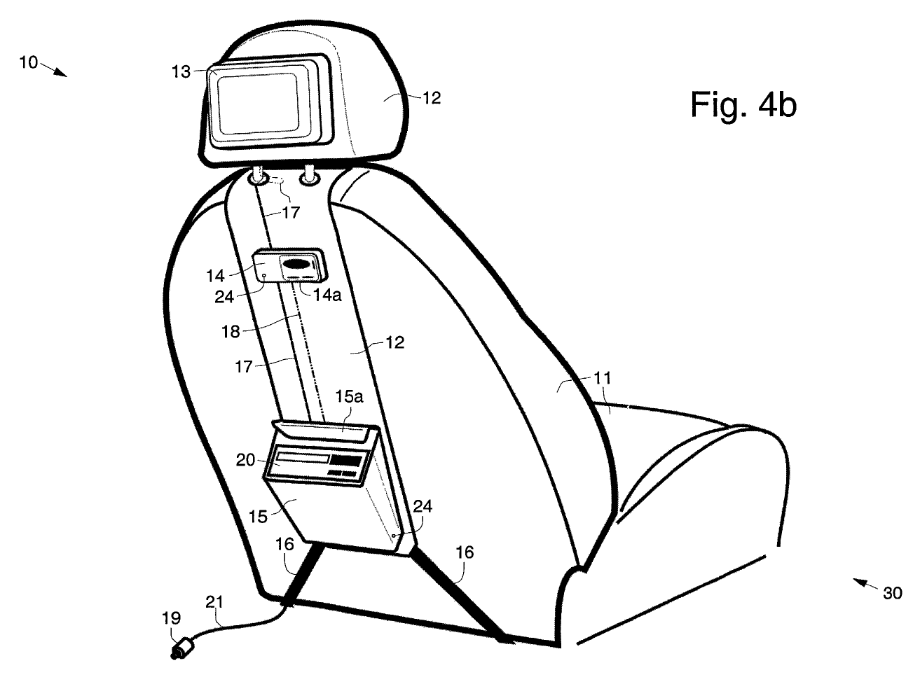

FIGS. 4a and 4b illustrate a fourth embodiment of a removable audio-video system 10 in accordance with the principles of the present invention. The fourth embodiment of the removable audio-video system 10 is a two-piece version that is used with headrests 11a that have rods that project into the seatback that allow raising and lowering of the headrest. The headrest 11a may have the video monitor 13 secured thereto by way of an attached cover or may have the built video monitor 13 in it. Thus, the present invention is designed to work with headrests 11a having built in video monitors 13 as well as those that do not.

The fourth embodiment of the removable audio-video system 10 includes a headrest cover portion 12a and a lower portion 12a that is captivated by the rods of the headrest and drapes down the back of the seat 11. The lower portion 12a of the cover 12 is secured by the straps 16 that are hooked or otherwise attached to the underside of the seat 11. The balance of the fourth embodiment of the removable audio-video system 10 is substantially the same as the first embodiment, and contains substantially the same components and connections. However, the video output cable 17 that is coupled between the DVD player 20 and the video monitor 13 extends outside the cover 12 and is exposed in the area of the rods of the headrest, or, in some instances is carried through the rod into the back of the seat 11 and connected to the main wire harness of the system 10 at the base of the seat 11. This allows for the use of a single power connection for the entire system 10 via the cigarette lighter adaptor 19 that plugs into the cigarette lighter or auxiliary power connector of the vehicle 30.

Thus, the present invention provides for a variety of removable audio-video systems 10 that are easily installed in a vehicle 30 without the need for fixed, expensive wiring installations such as are required for installation of conventional audio-video systems, while providing all the features and benefits of a fully integrated audio-video system without the limitations of conventional portable systems.

Thus, a number of removable audio-video systems have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. An audio-video system for use in a vehicle having a seat and a headrest, comprising:
a cover that covers the headrest and at least a portion of a back side of the seat;
a video reproducer attached to the cover;
an FM transmitter attached to the cover that is coupled to the video reproducer for broadcasting audio signals output by the video reproducer; and
a video monitor attached to the cover coupled to the video reproducer for displaying video signals output by the video reproducer.

2. The system recited in claim 1 further comprising a game port attached to the cover that is coupled to the video reproducer.

3. The system recited in claim 2 wherein the video reproducer and game port are located in a pocket attached to the cover

4. The system recited in claim 2 wherein the FM transmitter and game port are located in a pocket attached to the cover.

6. The system recited in claim 2 wherein the FM transmitter is coupled to the video reproducer by way of the game port.

7. The system recited in claim 1 wherein the video reproducer comprises a digital video disk player.

8. The system recited in claim 1 wherein the video reproducer is disposed in a pocket affixed to the cover.

9. The system recited in claim 1 further comprising wireless headphones for receiving audio signals from the FM transmitter.

10. The system recited in claim 2 wherein the video reproducer is coupled by way of the game port and cables routed within the cover to the video monitor and FM transmitter.

11. The system recited in claim 1 wherein the cover comprises a headrest cover.

12. The system recited in claim 1 wherein the cover comprises a headrest having the video monitor included therein.

13. The system recited in claim 1 wherein the cover comprises a seat cover.

14. The system recited in claim 1 wherein the game port comprises an automatic switching device that switches between the video reproducer and an auxiliary input source.

15. The system recited in claim 1 further comprising a single power connector coupled to the video reproducer, FM transmitter and video monitor for connection to a cigarette lighter or accessory power connector of the vehicle.

16. The system recited in claim 1 further comprising:
a second cover that covers a headrest and at least a portion of a back side of a second seat;
a second FM transmitter attached to the second cover that is coupled to the video reproducer for broadcasting audio signals output by the video reproducer; and
a second video monitor attached to the second cover coupled to the video reproducer for displaying video signals output by the video reproducer.

17. An audio-video system for use in a vehicle having a seat and a headrest, comprising:
a cover that covers the headrest and at least a portion of a back side of the seat;
a video reproducer attached to the cover;
a game port attached to the cover;
an FM transmitter attached to the cover and coupled to the video reproducer by way of the game port for broadcasting audio signals output by the video reproducer; and
a video monitor attached to the cover and coupled to the video reproducer by way of the game port that displays video signals output by the video reproducer.

18. The system recited in claim 17 further comprising a single power connector coupled to the video reproducer, game port, FM transmitter and video monitor for connection to a cigarette lighter or accessory power connector of the vehicle.

19. An audio-video system for use in a vehicle having a seat and a headrest, comprising:
a cover that covers the headrest and at least a portion of a back side of the seat;
a video reproducer attached to the cover;
a game port attached to the cover;
an FM transmitter attached to the cover and coupled to the video reproducer by way of the game port for broadcasting audio signals output by the video reproducer;
a video monitor attached to the cover and coupled to the video reproducer by way of the game port that displays video signals output by the video reproducer; and
a single power connector coupled to the video reproducer, game port, FM transmitter and video monitor for connection to a cigarette lighter or accessory power connector of the vehicle.
